(19) United States
(12) Patent Application Publication
(10) Pub. No.: US 2024/0425017 A1
(43) Pub. Date: Dec. 26, 2024

(54) SENSOR CLEANING WITH IMPROVED CLEANING LIQUID COLLECTION

(71) Applicant: Kautex Textron GmbH & Co. KG, Bonn (DE)

(72) Inventors: Chris Davies, Cardiff, South Wales (GB); Nelly Sierra, Bonn (DE); Hosur Naveen, Cardiff, South Wales (GB)

(21) Appl. No.: 18/694,469

(22) PCT Filed: Sep. 24, 2021
(86) PCT No.: PCT/EP2021/076357

§ 371 Date: Mar. 22, 2024

(51) Int. Cl. B60S 1/56; B60S 1/52; B60S 1/54

(52) U.S. Cl. CPC B60S 1/56; B60S 1/52; B60S 1/54

(57) ABSTRACT

The present invention discloses a sensor cleaning device (3) for cleaning an exterior sensor surface (4) of a sensor (2), in particular an optical camera or a LiDAR, for use in automotive applications, comprising—a dispensing device (6) with a cleaning liquid dispensing unit (7) for dispensing a cleaning liquid (8) towards the exterior sensor surface (4) of the sensor (2)—a collecting unit (12) for collecting cleaning liquid (8) dispensed from the dispensing device (6) towards the exterior sensor surface (4), wherein—the dispensing device (6) comprises a receiving fluid 7 connector (9) for receiving the cleaning liquid (8), and—the collecting unit (12) comprises at least one return fluid connector (17) for releasing collected cleaning liquid (8). The sensor cleaning device (3) is characterized in that,—the collecting unit (12) comprises a movable cover element (13). which is movable between a protruding position, in which the collecting unit (12) collects a maximum amount of the cleaning liquid (8) dispensed from the dispensing device (6) towards the exterior sensor surface (4) of the sensor (2) via its collecting opening (15), and a retracted position, in 10 which the cover element (13) is retracted into a position out of a field of view of the sensor (2). The present invention also discloses a sensor unit (1) comprising a sensor (2), in particular an optical camera or a LiDAR, for use in automotive applications and an above sensor cleaning device (3).

The present invention refers to a sensor cleaning device for cleaning an exterior sensor surface of a sensor, in particular an optical camera or a LiDAR, for use in automotive applications, comprising
a dispensing device with a cleaning liquid dispensing unit for dispensing a cleaning liquid towards the exterior sensor surface of the sensor,
a collecting unit for collecting cleaning liquid dispensed from the dispensing device towards the exterior sensor surface, wherein
the dispensing device comprises a receiving fluid connector for receiving the cleaning liquid, and
the collecting unit comprises at least one return fluid connector for releasing collected cleaning liquid.

The present invention also refers to a sensor unit comprising a sensor, in particular an optical camera or a LiDAR, for use in automotive applications and an above sensor cleaning device.

In current vehicles, an increasing number of sensors is provided to monitor an environment around the vehicle. Such sensors include in particular optical cameras including stereo cameras, LiDAR, and other sensors like radar sensors and ultrasonic sensors.

Based on a knowledge of the environment, possible dangerous situations for the vehicle, i.e., the ego vehicle, as well as for other traffic participants, can be identified and respective warnings can be generated or countermeasures can be started, e.g. braking the ego vehicle or taking a steering action to avoid a collision with an object ahead of the ego vehicle. This is particularly important when implementing driver assistance systems, which are e.g. known as ADAS (Advanced Driver Assistance Systems), or autonomous driving functions.

In all cases, it is required that the sensors continuously operate correctly and provide reliable sensor information. This requires a clean exterior sensor surface. The exterior sensor surface refers to a surface, which is an interface for the sensor to interact with the environment to gather the sensor information. However, in particular when referring to automotive applications, the sensors are frequently exposed to environmental conditions including rain and snow, which can be a cause for residual water droplets on the exterior sensor surface. Furthermore, solid particles can be disposed on the exterior sensor surface, e.g. dust particles, mud, splashes, smut and others.

Therefore, cleaning of the exterior sensor surface has become an important issue. One means for cleaning of the exterior sensor surface is dispensing a cleaning liquid onto the exterior sensor surface, which can wash away residual water droplets as well as solid particles. Preferably, the cleaning liquid is dispensed with high pressure to improve cleaning efficiency. In order to reduce consumption of the cleaning liquid, it is also known to recollect and even to reuse cleaning liquid dispensed onto the exterior sensor surface. The cleaning of the disclosed optical sensor requires continuous supply of washer fluid, which is expensive and is an annoying task for the driver of the vehicle. Furthermore, when the vehicle runs out of the washer fluid, cleaning of the sensor cannot be performed anymore, which reduces general traffic security for the ego vehicle as well as for third parties.

In this context, document US 2012 0117745 A1 discloses an onboard optical sensor cover including a holder and a washer nozzle. The holder holds an optical sensor. The optical sensor has a lens and is mounted above a window of a vehicle outside the vehicle. The washer nozzle performs a washing operation to wash a lens surface of the lens of the optical sensor held in the holder or a glass surface of a cover glass located facing the lens if the cover glass exists by spraying a washer fluid, supplied from a washer fluid tank, onto the lens surface or the glass surface. Furthermore, a casing of a sensor cover can be provided with a pan and a tube. When the washer fluid is sprayed from a spray opening of the washer nozzle onto the lens surface of the lens, the pan can catch the washer fluid dripping from the lens surface. The washer fluid caught by the pan can be drained through the tube.

A further problem is that the cleaning liquid dispensed onto the exterior sensor surface can cause splashes and deposition of cleaning liquid onto surrounding components of the vehicle, in particular a windshield of the vehicle, other sensors or just an exterior surface of the vehicle. This can cause an undesirable appearance of the vehicle with visible stains. Such stains can also reduce visibility for humans and other sensors through the windshield, other windows of the vehicle, or sensor surfaces of the other sensors, which can reduce traffic safety. In case highly reactive, corroding, aggressive cleaning liquids are used, this can imply a hazard to humans or animals close-by and even cause damage to the vehicle. Release of such aggressive cleaning liquids into the environment has to be prevented.

Therefore, it is an object of the present invention to provide a sensor cleaning device and a sensor unit comprising a sensor and a sensor cleaning device, which overcomes at least some of the problems of the state of the Art. It is a particular object of the present invention to reduce an amount of cleaning liquid, which cannot be collected. It is a still more particular object to enable efficient and extended cleaning of the exterior sensor surface with a reduced need for supply of cleaning liquid and a reduced loss of cleaning liquid as well as a reduction of stain due to splashes of cleaning liquid dispensed from the dispensing device and deposited onto surrounding components of the vehicle.

This object is achieved by the sensor cleaning device of present claim 1.

Advantageous embodiments of the sensor cleaning device are given in dependent claims 2 to 11.

In particular, the object is achieved by a sensor cleaning device for cleaning an exterior sensor surface of a sensor, in particular an optical camera or a LiDAR, for use in automotive applications, comprising
a dispensing device with a cleaning liquid dispensing unit for dispensing a cleaning liquid towards the exterior sensor surface of the sensor,
a collecting unit for collecting cleaning liquid dispensed from the dispensing device towards the exterior sensor surface, wherein
the dispensing device comprises a receiving fluid connector for receiving the cleaning liquid, and
the collecting unit comprises at least one return fluid connector for releasing collected cleaning liquid.

The inventive sensor cleaning device is characterized in that
the collecting unit comprises a movable cover element, which is movable between a protruding position, in which the collecting unit collects a maximum amount of the cleaning liquid dispensed from the dispensing device towards the exterior sensor surface of the sensor via its collecting opening, and a retracted position, in which the cover element is retracted into a position out of a field of view of the sensor.

With the movable cover element, the collecting capabilities of the collecting device for collecting the cleaning liquid dispensed from the dispensing device towards the exterior sensor surface of the sensor are increased in the protruding position, so that the maximum amount of the cleaning liquid can be collected. In the protruding position, the collecting opening enables due to its position and/or size the increased collection of the cleaning liquid. Consequently, a reduced amount of cleaning liquid dispensed from the dispensing device towards the exterior sensor surface of the sensor is lost. Accordingly, stains on the vehicle, e.g. on a windshield of the vehicle, other sensors or an exterior surface of the vehicle due to lost cleaning liquid are reduced. Limitations in the field of view, which can occur in the protruding position, are only temporary and are overcome in the retracted position, which is a normal position of the cover element. Further requirements of the cover element in the retracted position can be met, which can include a visual appearance of the sensor unit with the sensor cleaning device, aerodynamic requirements, or others. The collected cleaning liquid can be re-used or simply channeled away from the sensor cleaning device. Hence, the collected cleaning liquid can be channeled away from the sensor cleaning device e.g. to be released at a given location of the vehicle, or it can be channeled into a reservoir, either for re-use or for controlled release, e.g. in standstill of the vehicle or to release the collected cleaning liquid for controlled deposition.

In other words, the sensor cleaning device is switchable between a collecting mode, in which the movable cover element is moved into the protruding position, and a normal operation mode, in which the movable cover element is moved into the retracted position. In the collecting mode, the maximum amount of the cleaning liquid dispensed from the dispensing device towards the exterior sensor surface of the sensor is collected via the collector opening. In contrast, in the normal operation mode, entrance of solid particles and liquids into the collecting unit is reduced or even prevented, since the cover element forms a cover of the collecting unit and/or the collecting opening is closed and/or the collecting opening is reduced in size and/or the collecting opening is moved into a position, where it is blocked, e.g. by the sensor or other components of the sensor cleaning device. Accordingly, obstructions of the collecting unit and/or ducts connecting the collecting with e.g. a reservoir of cleaning liquid can be avoided. Furthermore, entry of unwanted liquids or impurities into the cleaning liquid can be prevented or reduced to maintain a desired quality of the cleaning liquid in case the cleaning liquid is re-used.

This is achieved with the movable cover element in the protruding position having an extension and/or positioning in an outward direction, i.e. in a direction above a top surface of the sensor unit, in particular a top wall of a housing of the sensor unit. In contrast, in the retracted position, the movable cover element is moved into an inward direction, i.e. opposite to the outward direction, so that the sensor cleaning device and/or the sensor unit can have a plain top face without protruding components.

The collection of the maximum amount of cleaning liquid refers to a maximum amount of cleaning liquid collected using the collecting unit in the protruding position compared to the retracted position of the cover element. It does not specify an absolute amount of cleaning liquid collected by the collecting unit.

The sensor cleaning device can be used for cleaning exterior sensor surfaces of any kind of sensor. Due to a typically exposed placement as well as working principles of the different types of sensors, such sensor cleaning devices are most beneficial for use with optical cameras or LiDARs (Light Detection And Ranging) based on light. The use in automotive applications is a typical cause for particles and droplets disposed on the exterior sensor surface.

The dispensing device comprises the cleaning liquid dispensing unit for dispensing the cleaning liquid towards the exterior sensor surface of the sensor. Hence, cleaning of the exterior sensor surface includes washing of the exterior sensor surface, which improves cleaning efficiency. Cleaning efficiency can be further improved, when the cleaning liquid dispensing unit dispenses pressurized cleaning liquid. The sensor cleaning device can comprise a pump for pumping the cleaning liquid from a reservoir and providing the pressurized cleaning liquid to the cleaning liquid dispensing unit. Alternatively, the pressurized cleaning liquid is provided directly to the cleaning liquid dispensing unit via the receiving fluid connector. It is preferred that the cleaning liquid dispensing unit comprises a nozzle for dispensing pressurized cleaning liquid.

In an alternative embodiment, the sensor cleaning device comprises a pump and/or a reservoir. The reservoir stores cleaning liquid. The pump transports the cleaning liquid to the dispensing device, preferably from the reservoir. Furthermore, the pump can provide the cleaning liquid as pressurized cleaning liquid.

The cleaning liquid can be water or any other suitable cleaning liquid.

The collecting unit collects the cleaning liquid dispensed from the cleaning liquid dispensing unit towards the exterior sensor surface of the sensor. The collecting unit has at least one outlet opening for releasing the collected cleaning liquid. For an efficient operation, it is preferred that the sensor cleaning device is positioned so that the dispensing device is located above the sensor and the collecting unit is located below the sensor when mounted at the vehicle in a direction of gravity. This facilitates collection of the cleaning liquid dispensed from the cleaning liquid dispensing unit. Preferably, also the collecting unit is designed so that the collected cleaning liquid is passed to the outlet opening based on gravity, i.e. in a passive manner.

The sensor cleaning device receives the cleaning liquid via the receiving fluid connector. The cleaning liquid can be received as pressurized cleaning liquid, as discussed above, or at ambient pressure. The collected cleaning liquid is released from the collecting unit via the return fluid connector. The cleaning liquid is typically released into a reservoir. The reservoir is preferably located below the collecting unit so that the collected cleaning liquid can be transported based on gravity from the collecting unit to the reservoir.

The movable cover element can have any suitable shape and perform any suitable movement to move between the protruding position and the retracted position. Some detailed specifications are given below by way of example.

In addition to the cover element, also the dispensing device, in particular the cleaning liquid dispensing unit for dispensing the cleaning liquid towards the exterior sensor surface, can be movable between a protruding position and a retracted position. Accordingly, in the protruding position of the dispensing device, the cleaning liquid can be dispensed onto the exterior sensor surface with a steeper angle compared to the retracted position, which typically improves the cleaning of the exterior sensor surface and increases cleaning efficiency. In the retracted position, the dispensing device, in particular the cleaning liquid dispensing unit, is retracted into a position out of a field of view of the sensor. In this case, the movement of the dispensing device, in particular the cleaning liquid dispensing unit, is preferably coupled to the movement of the cover element. Hence, the dispensing device, in particular the cleaning liquid dispensing unit, and the cover element preferably move synchronically. Additionally or alternatively, the movement of the dispensing device can be coupled to a start/stop of a dispensing operation of the dispensing device.

Furthermore, the entire sensor cleaning device can be movable between a protruding position and a retracted position. The movement refers to a movement relative to the sensor, which has a fix position in this case. The sensor cleaning device can be movably held in a support, so that it can be moved between the two positions. The same principles as discussed in respect to the movable cover element apply.

According to a preferred embodiment, the collecting unit comprises a collecting base for guiding collected cleaning liquid to the at least one return fluid connector, wherein
the cover element is movable relative to the collecting base and the collecting opening is formed between the collecting base and the cover element in the protruding position, and/or
the cover element is movable relative to the collecting base, the collecting opening is formed between the collecting base and the cover element, and a size of the collecting opening is increased when the cover element is moved into the protruding position, and/or
the cover element is movable together with the collecting base, and the collecting opening is formed between the collecting base and the cover element, so that the collecting opening moves with the collecting base and the cover element, wherein
in the protruding position a maximum amount of the cleaning liquid dispensed from the dispensing device towards the exterior sensor surface of the sensor is collected through the collecting opening.

In general, the cover element and the collecting base together form an inlet for the cleaning liquid, wherein the cleaning liquid, that has entered a space between the cover element and the collecting base is trapped there between and preferably leaves this space and the collecting unit only through the at least one return fluid connector. However, different ways of movement of the cover element and forming of the collecting opening are possible. With the cover element movable relative to the collecting base, the collecting opening can be opened or created with a beginning movement of the cover element from the retracted position into the protruding position. The further the cover element is moved away from the collecting base, the bigger the collecting opening, until it reaches its maximum size in the protruding position. In the retracted position, the collecting opening is not present. In another embodiment, with the cover element movable relative to the collecting base, the collecting opening between the collecting base and the cover element is permanently present also in the retracted position, wherein the movement of the cover element between the retracted position and the protruding position changes the size of the collecting opening. The size of the collecting opening is increased when the cover element is moved towards the protruding position and reduced when the cover element is moved towards the retracted position. In other words, the movement of the cover element relative to the collecting base results in a change of size of the collecting opening, wherein the further the cover element is moved away from the collecting base, the bigger the collecting opening. In a yet further embodiment, the cover element is coupled with the collecting base and moves together with the collecting base. The collecting opening is formed between the collecting base and the cover element with a fix size. When the cover element moves, also the collecting base and the collecting opening move. In the protruding position, the collecting opening is positioned in a way that enables that the maximum amount of the cleaning liquid dispensed from the dispensing device towards the exterior sensor surface of the sensor is collected through the collecting opening. When the cover element is moved together with the base element from the protruding position towards the retracted position, a decreasing portion of the collecting opening is located in a position where the cleaning liquid can enter through the collecting opening. In this embodiment, the cover element and the collecting base can be provided integrally as a single piece.

The collecting base is preferably provided with at least one outlet opening for releasing the cleaning liquid collected therein through the return fluid connector.

According to a preferred embodiment, the collecting base and/or the cover element is formed to provide the collecting opening with its shape in accordance with a shape of a functional element of the sensor, e.g. a sensor lens or a prism, or a protection element of the sensor, wherein the exterior sensor surface is a surface of the functional element or the protection element. Providing the collecting opening with its shape in accordance with the shape of the functional element or the protection element enables allocation of the cover element in close proximity to the respective functional element or protection element. Gaps between the cover element and the functional element or the protection element can be reduced, which is aerodynamically preferred. The shape of the functional element or the protection element refers to a planar shape with the exterior sensor surface provided on top thereof. For example, the shape can be circular, and the collecting base and/or the cover element is formed to provide the collecting opening with a corresponding e.g. semicircular shape.

According to a preferred embodiment, the collecting unit comprises an actuator device with at east one actuator unit for moving the cover element between the retracted position and the protruding position, wherein
the at least one actuator unit is an electronically driven actuator unit, e.g. an electric motor, and/or
the at least one actuator unit is a mechanically driven actuator unit, and/or
the at least one actuator unit is a hydraulically driven actuator unit, and/or
the at least one actuator unit is a pneumatically driven actuator unit.

The electronically driven actuator unit comprises e.g. an electric motor and a gear for moving the cover element. The mechanically driven actuator unit can comprise a gear and/or shafts to transfer a mechanical movement into the movement of the cover element. The hydraulically driven actuator unit comprises a hydraulic port for receiving a pressurized hydraulic liquid. Preferably, the hydraulic port is connected to receive the cleaning liquid as hydraulic liquid. The pneumatically driven actuator unit comprises a pneumatic port for receiving a pressurized gas, in particular pressurized air. In case of the hydraulically driven actuator unit or the pneumatically driven actuator unit, the respective actuator unit comprises a piston, which is displaced by a force of the hydraulic liquid or the pressurized gas. In each case, the actuator unit is preferably operated to move the cover element in accordance with the operation of the dispensing device. The actuator device can comprise one actuator unit, which moves the cover element. Central support of the cover element is preferred in this case. The one actuator unit can support the cover element at multiple supporting points. In an alternative embodiment, multiple actuator units can be provided commonly to move the cover element. Preferably, multiple actuator units of the same kind are provided commonly. Hence, the actuator device comprises e.g. two or more actuator units, which commonly move the cover element. In case of the hydraulically or pneumatically driven actuator units, multiple pistons can be provided to exert a force onto the cover element. The hydraulically or pneumatically driven actuator units can share a single hydraulic or pneumatic port, respectively, or each of the hydraulically or pneumatically driven actuator units is provided individually with a hydraulic or pneumatic port, respectively. The multiple pistons can be provided to provide a symmetrical support of the cover element and/or a lateral support of the cover element.

According to a preferred embodiment, the actuator device comprises a biasing element, in particular a spring element, for biasing the cover element into the retracted position. The respective actuator unit creates a force against the biasing element to move the cover element from the retracted position into the protruding position. When the actuator unit does not exert a force onto the cover element, the biasing element automatically moves the cover element towards the retracted position. In other words, the biasing element serves as actuator unit moving the cover element from the protruding position towards or into the retracted position.

According to a preferred embodiment, the sensor cleaning device is provided with a coupling between the dispensing device and the actuator device to move the cover element into the protruding position, when the cleaning liquid dispensing unit dispenses the cleaning liquid. Different kinds of couplings can be applied, e.g. electronic coupling, mechanical coupling, hydraulic coupling, or pneumatic coupling. Preferably, the cover element is moved into the protruding position as soon as the cleaning liquid dispensing unit starts dispensing the cleaning liquid. Further preferred, the coupling includes that the cover element is moved into the retracted position as soon as the cleaning liquid dispensing unit stops dispensing the cleaning liquid. In each case, delays between the start and/or stop of the dispensing operation and the movement of the cover element can be implemented.

According to a preferred embodiment, the sensor cleaning device comprises a control unit, which performs a control of the dispensing device and/or the actuator device to move the cover element into the protruding position, when the cleaning liquid dispensing unit dispenses the cleaning liquid. In an alternative embodiment, the dispensing device and the actuator device are both operated by a supply of pressurized cleaning liquid. The control unit provides a functional coupling between the dispensing device and the actuator device. The control unit can act on any kind of actuator unit, e.g. by driving a motor or opening a hydraulic or pneumatic valve. The control unit enables an intelligent control of the dispensing device and/or the actuator device so as to move the cover element already into the protruding position shortly before the dispensing device starts dispensing the cleaning liquid and/or to move the cover element into the retracted position with a delay after the dispensing device stops dispensing the cleaning liquid. The control unit can receive an external control signal to move the cover element into the protruding position, e.g. when a pump for supplying the cleaning liquid to the dispensing device is started, and another control signal to move the cover element into the retracted position. Alternatively, the control unit generates a control signal to start and/or to stop supply of cleaning liquid to the dispensing device, e.g. using the pump, and moves the cover element depending on the generation of the control signal(s). In a further embodiment, the control unit receives a sensor information indicative of the dispensing unit dispensing a cleaning liquid towards the exterior sensor surface of the sensor and moves the cover element depending on the sensor information. In case the dispensing device and the actuator device are both operated by a supply of pressurized cleaning liquid, a hydraulic coupling is realized. The hydraulic coupling can be realized by connecting the receiving fluid connector of the dispensing device in parallel with a hydraulic port of the actuator device, which is a hydraulically operated actuator device in this case, to a supply of pressurized cleaning liquid. Accordingly, the cover element automatically moves into the protruding position when the dispensing device starts dispensing the cleaning liquid. When the supply of pressurized cleaning liquid is stopped, the dispensing device stops dispensing the cleaning liquid, and the cover element can be moved back into the retracted position, for example by way of a biasing element.

According to a preferred embodiment, the at least one actuator unit for moving the cover element is located in an area below the cover element and performs a direct pulling and/or pushing movement of the cover element, and/or the at least one actuator unit for moving the cover element is located laterally displaced to the area below the cover element and is connected with the cover element with a connecting rod. The area below the cover element can be defined based on a movement axis of the cover element from the retracted position into the protruding position and/or of the actuator unit, e.g. a corresponding movement of a piston of the actuator unit. The area below the cover element is located in respect to this movement axis below the cover element in the retracted position. When the at least one actuator unit for moving the cover element is located below the cover element, a simple and stable mechanical setup can be provided. In case a biasing element is used to move the cover element into the retracted position, i.e. the actuator unit does not pull the cover element, no fix connection between the actuator unit and the cover element is required. For example, a piston of the actuator unit can be located below the cover element to the push directly against the cover element. The location of the at least one actuator unit in an area below the cover element enables provisioning of the sensor cleaning device and the respective sensor unit with a reduced lateral extension, i.e. a small width. In case the at least one actuator unit for moving the cover element is located laterally displaced to the area below the cover element, the sensor cleaning device and the respective sensor unit can be provided with a reduced height.

According to a preferred embodiment,
the cover element is attached with a hinge and performs a tiling movement between the retracted position and the protruding position, and/or
the cover element is movable in a linear direction along a movement axis, and/or
the cover element is movable with a guide mechanism along a defined movement path.

Hence, the cover element can perform different kinds of movement, each of which enables the movement between the protruding position and the retracted position. In case of the tilting movement, the hinge is provided laterally at one side of the cover element, and the collecting opening is provided laterally at an opposite side of the hinge. In case of the linear movement, the movement axis defines a movement axis of the cover element. A typical movement of the cover element is in an upward/downward direction, e.g. transverse to an extension of the exterior sensor surface. However, in an alternative embodiment, the cover element can be moved within a plane of the exterior sensor surface. In this case, in the protruding position, the cover element is located closer to the exterior sensor surface than in the retracted position. Also in this case, in the protruding position, collection of the cleaning liquid dispensed from the dispensing device towards the exterior sensor surface of the sensor via the collecting opening is facilitated, and in the retracted position, the cover element is retracted into a position out of a field of view of the sensor. In case of the guide mechanism, the cover element can perform a movement along the movement path as defined by the guide mechanism, e.g. a combined movement transverse to the extension of the exterior sensor surface and in the plane of the exterior sensor surface.

According to a preferred embodiment, the dispensing device comprises a gas dispensing unit for releasing pressurized gas into a direction of the exterior sensor surface of the sensor. The release of pressurized gas can further improve cleaning efficiency of the sensor cleaning device. The pressurized gas can blow away droplets of water, e.g. due to rain, or dust from the exterior sensor surface. Each of the gas dispensing unit and the cleaning liquid dispensing unit can be operated independently. However, the gas dispensing unit and the cleaning liquid dispensing unit are preferably operated together for further improving cleaning efficiency. The gas dispensing unit and the cleaning liquid dispensing unit can be operated in parallel, partially in parallel, or with a delay for commonly cleaning the exterior sensor surface. For example, in order to remove droplets of cleaning liquid remaining on the exterior sensor surface after dispensing the cleaning liquid towards the exterior sensor surface of the sensor, it can be preferred to operate the gas dispensing unit after the cleaning liquid dispensing unit. The pressurized gas is received via a receiving gas connector. Preferably, the pressurized gas is pressurized air. In general, the principles discussed in respect to the cleaning liquid dispensing unit can be applied also to the gas dispensing unit.

According to a preferred embodiment, the exterior sensor surface of the sensor is an exterior sensor surface of a functional element of the sensor, e.g. a sensor lens or a prism, or the exterior sensor surface of the sensor is an exterior sensor surface of a protection element, in particular of a functional element of the sensor. The cleaning can be applied regardless of the kind of element having the exterior sensor surface. The protection element is preferably transparent for the sensor. In case of an optical sensor, the protection element is transparent for light. The functional element can be protected by the protection element. The protection element is preferably part of the sensor cleaning device or the sensor unit. Alternatively, the protection element can be part of the vehicle.

According to a preferred embodiment, the sensor cleaning device comprises receiving means for receiving the sensor. Accordingly, the sensor can be easily mounted to the sensor cleaning device to form the sensor unit.

The object is also achieved by the sensor unit of present claim 12.

Advantageous embodiments of the sensor cleaning device are given in dependent claims 13 to 15.

In particular, the object is achieved by a sensor unit comprising a sensor, in particular an optical camera or a LiDAR, for use in automotive applications and an above described sensor cleaning device.

The features, detailed embodiments and advantages described in respect to the sensor unit can be applied directly to the sensor cleaning device and vice versa.

The sensor unit is formed by a combination of the sensor and the above sensor cleaning device. The sensor unit can be provided as integral device, which can be mounted to the vehicle in a single mounting step.

According to a preferred embodiment, the sensor unit comprises a housing, which at least partially encloses the sensor and the sensor cleaning device, wherein
the housing has a top wall,
in the protruding position, the cover element protrudes from the top wall in an outward direction, and
in the retracted position, a top face of the cover element extends essentially flush with the top wall.

The housing can have any suitable shape including a tubular shape or a cuboidal shape. The sensor unit is typically mounted at the vehicle so that the top wall seamlessly integrates into an outer skin of the vehicle. Hence, in the retracted position, the entire top face of the sensor unit can seamlessly integrate into the outer skin of the vehicle. The top wall is preferably provided as essentially flat wall. The top wall preferably has a sensor opening. The sensor opening can be provided centrally or at any other location of the top wall. The top wall can have further openings for the cleaning device, in particular for the cover element and/or the dispensing device.

According to an alternative embodiment, the sensor cleaning device comprises a housing, and a sensor can be received at least partially in the housing, wherein
the housing has a top wall,
in the protruding position, the cover element protrudes from the top wall in an outward direction, and
in the retracted position, a top face of the cover element extends essentially flush with the top wall.

Hence, the above principles discussed with reference to the sensor unit having the housing also apply to the sensor cleaning device comprising the housing.

In a further embodiment, a vehicle is provided with at least one sensor unit comprising a sensor, in particular an optical camera or a LiDAR, for use in automotive applications and a sensor cleaning device as discussed above. The vehicle is provided with an outer skin defining its outer shape, and the sensor unit is integrated into the outer skin so that
in the protruding position, the cover element protrudes from the outer skin in an outward direction, and
in the retracted position, a top face of the cover element extends essentially flush with the outer skin.

Hence, the above principles discussed with reference to the sensor unit having the housing also apply to the sensor cleaning device integrated into the outer skin of the vehicle. Preferably, the sensor unit is mounted first with the sensor cleaning device and the sensor, so that the sensor unit can be mounted entirely to the vehicle in a single mounting step. However, it is also possible to mount first the sensor cleaning device at the vehicle and second to mount the sensor directly to the vehicle or at the sensor cleaning device.

According to a preferred embodiment, the sensor unit is provided with latching means for latching mounting the sensor unit in a corresponding receptacle of a vehicle, wherein the latching means are preferably provided at a lateral wall of a housing of the sensor unit, which at least partially encloses the sensor and the sensor cleaning device. The latching mounting can be easily achieved in a short time. Additionally, the receiving fluid connector and the at least one return fluid connector for releasing collected cleaning liquid have to be connected for mounting the sensor unit. These connections can be made e.g. as plug connection or others.

According to a preferred embodiment, the sensor unit comprises a reservoir for storing cleaning liquid, the sensor unit comprises a pump unit, which delivers cleaning liquid from the reservoir to a supply duct, which is connected to the receiving fluid connector of the dispensing device. Such a sensor unit can be used e.g. as autonomous device or stand-alone device without connection to further supplies of the vehicle. Preferably, the pump unit delivers pressurized cleaning liquid to the dispensing device for improved cleaning of the exterior sensor surface. In a preferred embodiment, the delivery duct is additionally connected to a hydraulically driven actuator unit of an actuator device for moving the cover element. Accordingly, the pressurized cleaning liquid is provided from the pump unit to the hydraulically driven actuator unit to move the cover element. In a preferred embodiment, the at least one return fluid connector of the collecting unit is connected via a return duct to the reservoir. Hence, the reservoir, the dispensing device with the cleaning liquid dispensing unit, the collecting unit and the connecting ducts can form a loop with minimized loss of cleaning liquid when cleaning the exterior sensor surface. Additionally, a filter for filtering the collected cleaning liquid can be provided. The return duct preferably returns the cleaning liquid from the collecting unit in a passive way, e.g. by means of gravity, or a further pump is provided to transfer the cleaning liquid from the collecting unit through the return duct into the reservoir.

In an alternative embodiment, only the pump is part of the sensor unit, and the sensor unit is connected e.g. to a central reservoir via the supply duct and the return duct.

According to a preferred embodiment, the dispensing device and the collecting unit are positioned circumferentially around the sensor, in particular around the exterior sensor surface of the sensor, wherein preferably the dispensing device and the collecting unit are positioned at diametrically opposite positions in respect to the sensor. This arrangement of the dispensing device and the collecting unit enables an efficient collection of the cleaning liquid. Preferably, the collecting unit is located below the dispensing device to make use of gravity for collecting the cleaning liquid.

The object is also achieved by the sensor unit of present claim 16.

In particular, the object is achieved by a sensor unit comprising a sensor, in particular an optical camera or a LiDAR, for use in automotive applications and a sensor cleaning device, wherein the sensor cleaning device is provided for cleaning an exterior sensor surface of the sensor, comprising
a dispensing device with a cleaning liquid dispensing unit for dispensing a cleaning liquid towards the exterior sensor surface of the sensor,
a collecting unit for collecting cleaning liquid dispensed from the dispensing device towards the exterior sensor surface, wherein
the dispensing device comprises a receiving fluid connector for receiving the cleaning liquid, and
the collecting unit comprises at least one return fluid connector for releasing collected cleaning liquid.

The sensor unit is characterized in that,
the sensor cleaning device is movable relative to the sensor between a protruding position, in which the collecting unit collects a maximum amount of the cleaning liquid dispensed from the dispensing device towards the exterior sensor surface of the sensor via its collecting opening, and a retracted position, in which the sensor cleaning device is retracted into a position out of a field of view of the sensor.

Hence, the entire sensor cleaning device is movable relative to the sensor. The sensor unit can comprise a support for movably supporting the sensor cleaning device, so that it can be moved to reach the two positions. In this case, the sensor has a fix mounting position in the sensor unit. In an alternative embodiment, the sensor is movable with respect to the sensor cleaning device. In this case, the sensor cleaning device has a fix mounting position in the sensor unit.

The collecting unit can have a cover element, which moves together with the entire sensor cleaning device. The collecting unit can further have a collecting base, and the collecting opening is formed between the collecting base and the cover element, so that the collecting opening moves with the collecting base and the cover element. In the protruding position, a maximum amount of the cleaning liquid dispensed from the dispensing device towards the exterior sensor surface of the sensor is collected through the collecting opening. The cover element can be coupled with a collecting base, so that they move together. The collecting opening is formed between the collecting base and the cover element with a fix size. When the sensor cleaning device moves, also the collecting opening moves relative to the sensor. In the protruding position, the collecting opening is positioned in a way that enables that the maximum amount of the cleaning liquid dispensed from the dispensing device towards the exterior sensor surface of the sensor is collected through the collecting opening. When the sensor cleaning device is moved from the protruding position towards the retracted position, a decreasing portion of the collecting opening is located in a position where the cleaning liquid can enter through the collecting opening. The cover element and the collecting base can be provided integrally as a single piece.

The same principles as discussed in respect to the movable cover element apply. For example, a protruding position of the movable cover element corresponds to a protruding position of the sensor cleaning device relative to the sensor, and a retracted position of the movable cover element corresponds to a retracted position of the sensor cleaning device relative to the sensor.

These and other aspects of the invention will be apparent from and elucidated with reference to the embodiments described hereinafter. Individual features disclosed in the embodiments can constitute alone or in combination an aspect of the present invention. Features of the different embodiments can be carried over from one embodiment to another embodiment.

In the drawings:

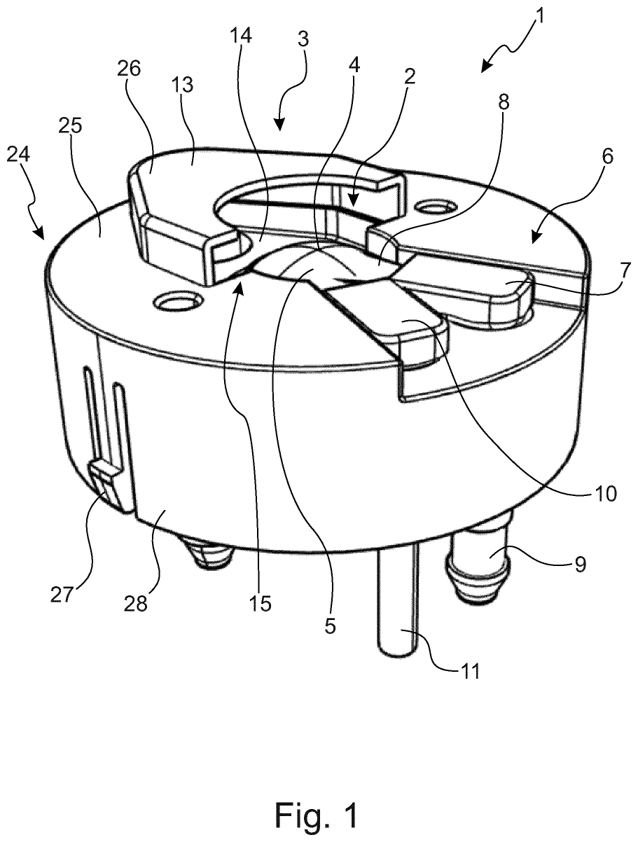

FIG. 1: shows a perspective view of a sensor unit with a sensor, a sensor cleaning device and a housing according to a first, preferred embodiment, wherein the sensor cleaning device comprises a movable cover element, which is positioned in a protruding position;

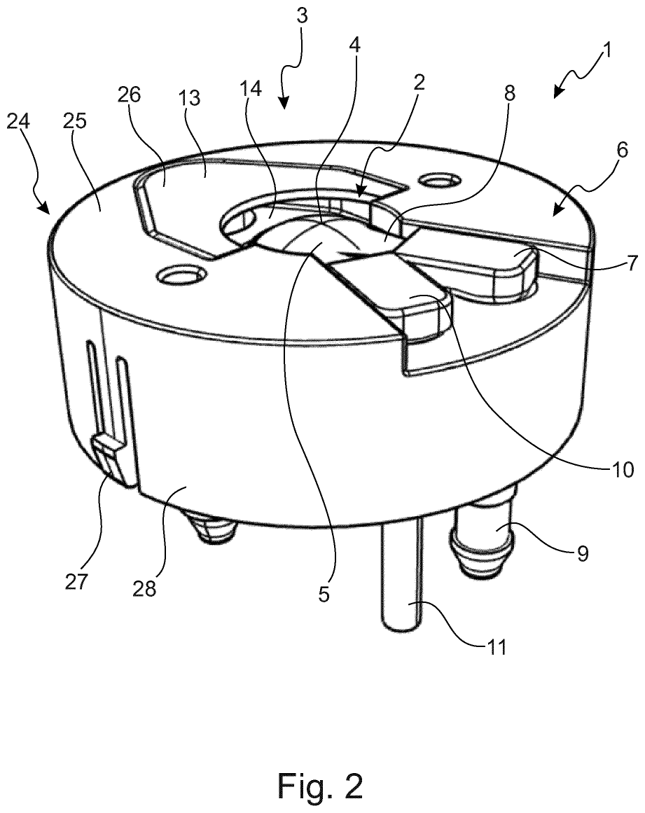

FIG. 2: shows a perspective view of the sensor unit shown in FIG. 1, wherein the movable cover element is positioned in a retracted position;

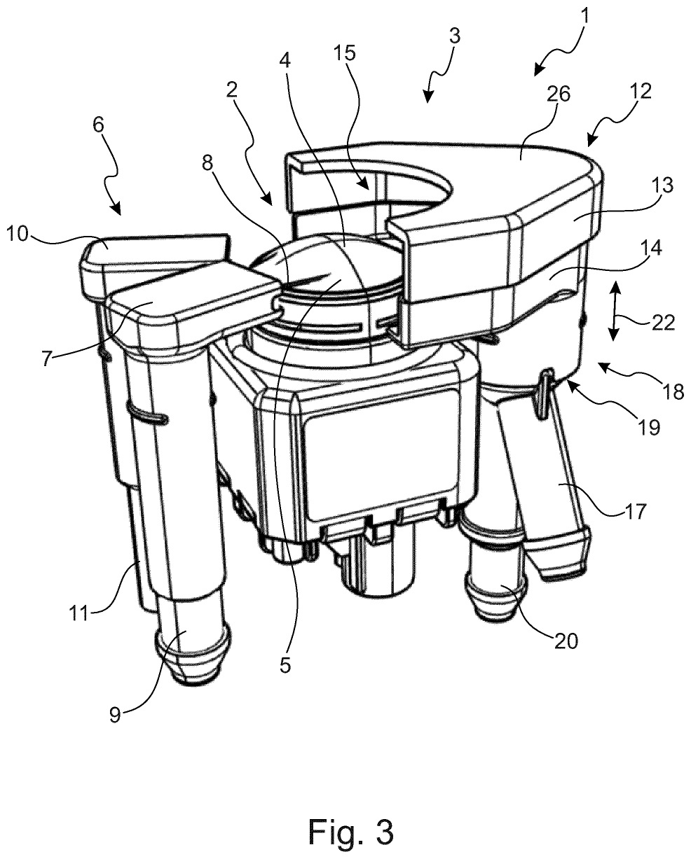

FIG. 3: shows a perspective view of the sensor unit shown in FIG. 1, wherein the housing is removed;

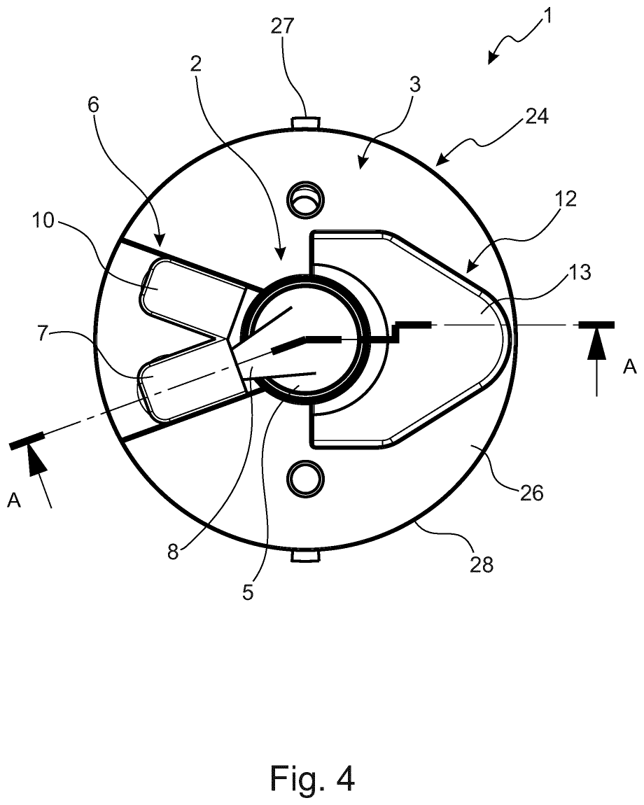

FIG. 4: shows a top view of the sensor unit shown in FIG. 1 with the housing and a line of a sectional view;

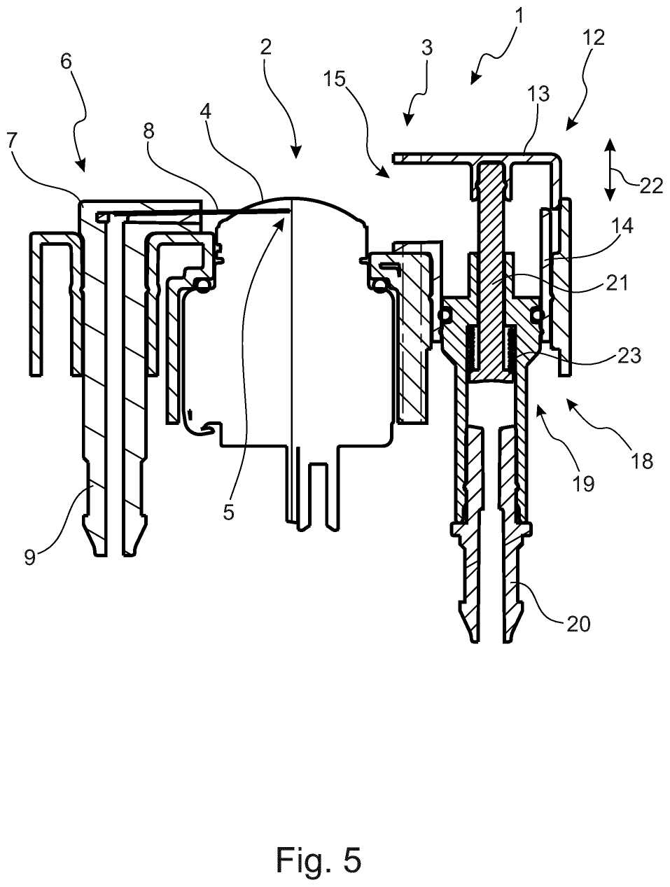

FIG. 5: shows a sectional view of the sensor unit of FIG. 1 along the line of the sectional view of FIG. 4, wherein the movable cover element is positioned in the protruding position;

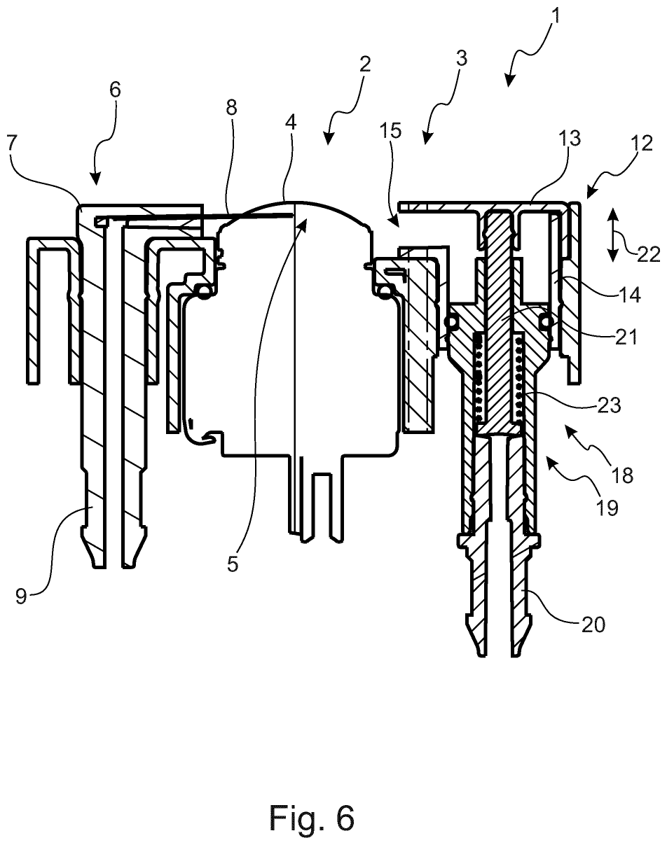

FIG. 6: shows a sectional view of the sensor unit of FIG. 1 along the line of the sectional view of FIG. 4, wherein the movable cover element is positioned in the retracted position;

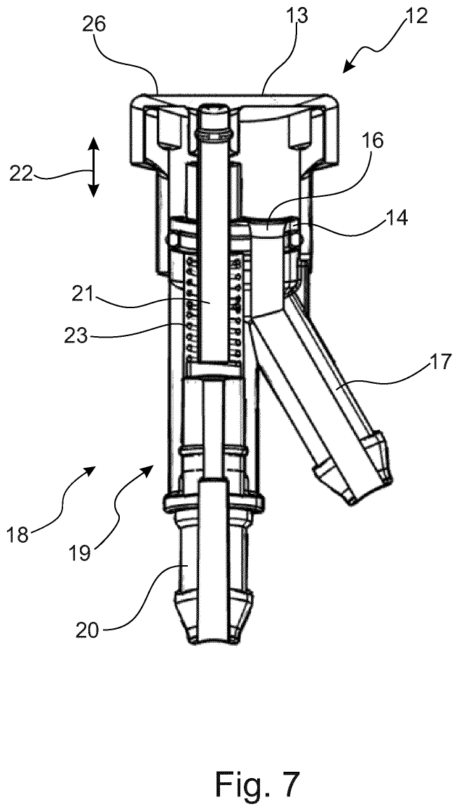

FIG. 7: shows a sectional view of a collecting unit of the sensor unit of FIG. 1 together with an actuator device with one actuator unit and a biasing spring;

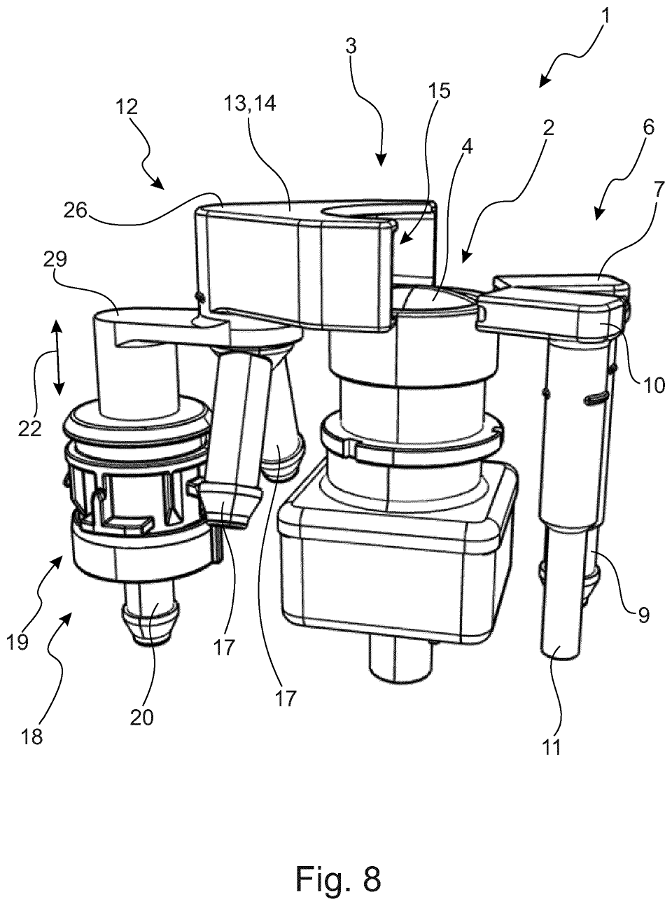

FIG. 8: shows a perspective view of a sensor unit according to a second embodiment with a sensor and a sensor cleaning device, wherein the sensor cleaning device comprises a collecting unit with a movable cover element together with a collecting base, and the cover element is positioned together with the collecting base in a protruding position;

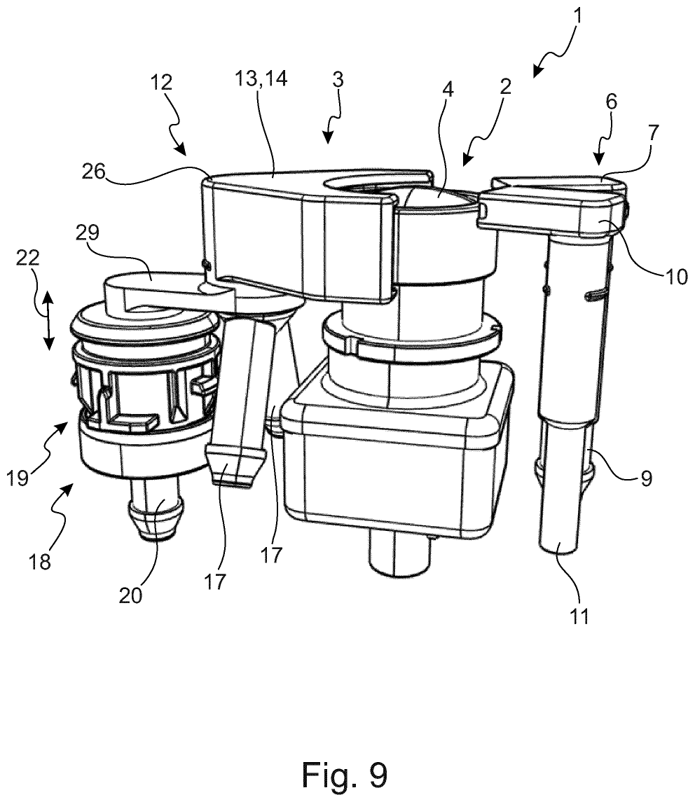

FIG. 9: shows a perspective view of the sensor unit shown in FIG. 8, wherein the cover element is positioned together with the collecting base in a retracted position;

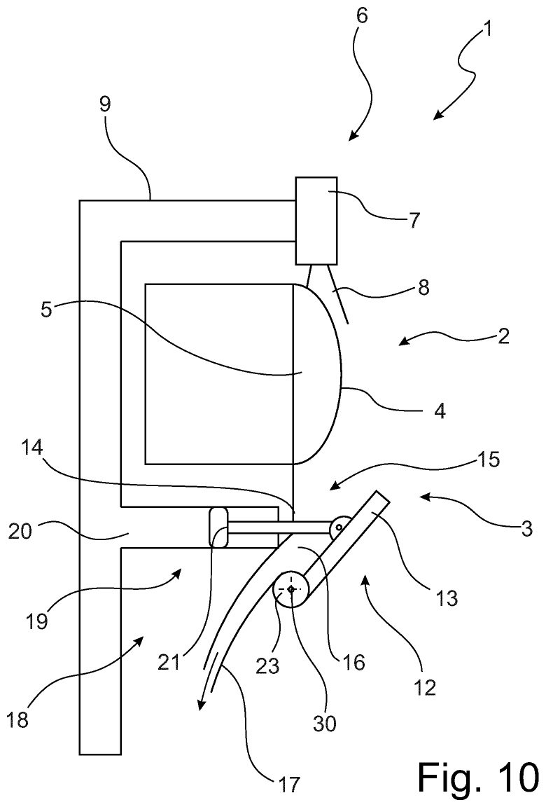

FIG. 10: shows a schematic lateral view of a sensor unit according to a third embodiment with a sensor and a sensor cleaning device, wherein the sensor cleaning device comprises a collecting unit with a movable cover element in a protruding position, and the cover element is attached with a hinge and performs a tiling movement;

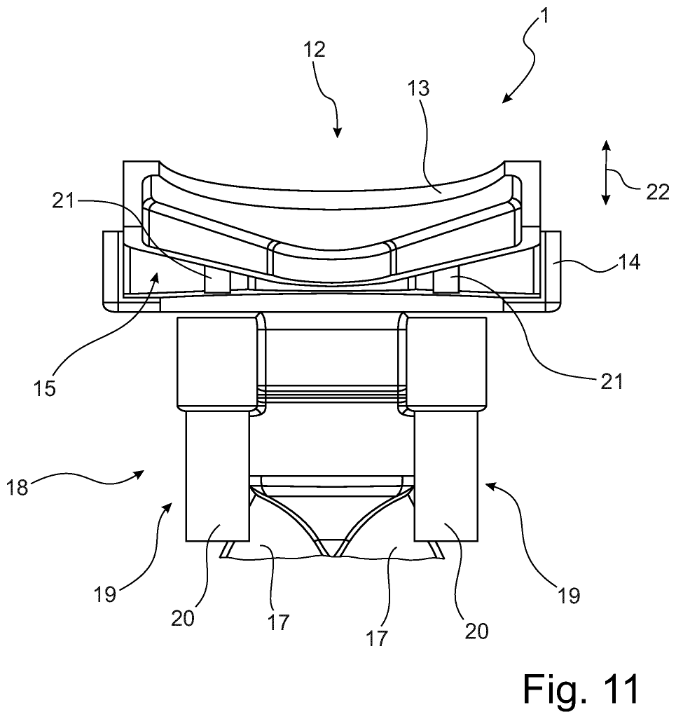

FIG. 11: shows a partial perspective view of a sensor unit according to a fourth embodiment with a collecting unit of the sensor cleaning device having an actuator device with two actuator units for moving a movable cover element, wherein the cover element is positioned in a protruding position; and

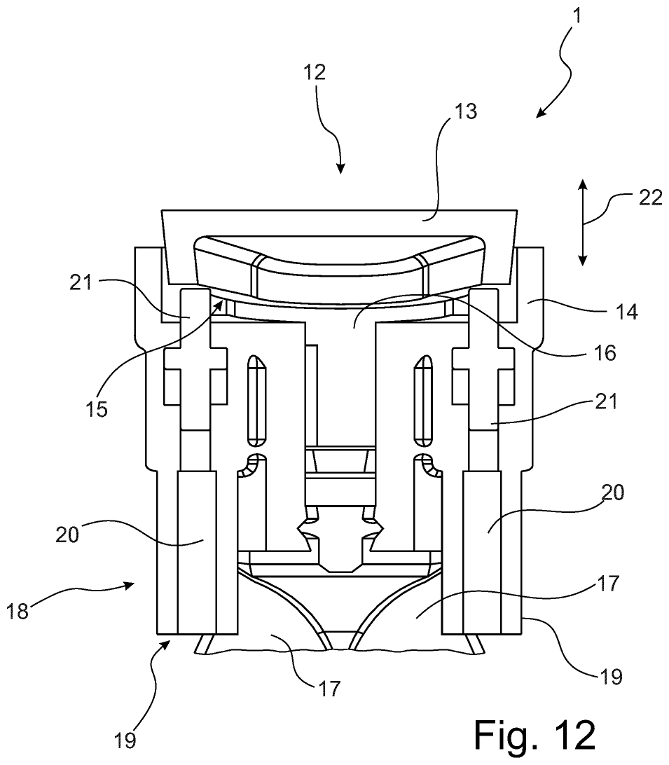

FIG. 12: shows a sectional view of the collecting unit and actuator device with the two actuator units for moving a movable cover element of FIG. 10, wherein the cover element is positioned in the protruding position.

In the following description of embodiments, similar features or components are referred to by the same reference numerals. A description of a component made in respect to one of the figures also applies to other figures in order to avoid a repeated description thereof. Furthermore, individual features described in respect to one embodiment can be embodied separately in other embodiments. Similarly, features described with respect to a method can be applied to a respective apparatus and vice versa.

FIGS. 1 to 7 show a sensor unit 1 according to a first, preferred embodiment.

The sensor unit 1 comprises a sensor 2, which is an optical camera for use in automotive applications. In an alternative embodiment, the sensor is a LiDAR (Light Detection And Ranging).

The sensor unit 1 also comprises a sensor cleaning device 3 for cleaning an exterior sensor surface 4 of the sensor 2. In this embodiment, the exterior sensor surface 4 of the sensor 2 is an exterior sensor surface 4 of a functional element 5 of the sensor 2, e.g. a sensor lens.

As can be best seen in FIG. 3, the sensor cleaning device 3 comprises a dispensing device 6 with a cleaning liquid dispensing unit 7 for dispensing a cleaning liquid 8 towards the exterior sensor surface 4 of the sensor 2. In this embodiment, water is used as cleaning liquid 8. The cleaning liquid dispensing unit 7 comprises a nozzle for dispensing pressurized cleaning liquid 8, as further discussed below. The pressurized cleaning liquid 8 is received via receiving fluid connector 9.

The dispensing device 6 also comprises a gas dispensing unit 10 for releasing pressurized gas into a direction of the exterior sensor surface 4 of the sensor 2. Each of the gas dispensing unit 10 and the cleaning liquid dispensing unit 7 can be operated independently. However, the gas dispensing unit 10 and the cleaning liquid dispensing unit 7 are preferably operated together for further improving cleaning efficiency. The gas dispensing unit 10 and the cleaning liquid dispensing unit 7 can be operated in parallel, partially in parallel, or with a delay for commonly cleaning the exterior sensor surface 4. The pressurized gas is received via receiving gas connector 11. In this embodiment, the pressurized gas is pressurized air.

As can be seen e.g. in FIGS. 3, 5 and 6, the sensor cleaning device 3 further comprises a collecting unit 12 for collecting cleaning liquid 8 dispensed from the dispensing device 6 towards the exterior sensor surface 4.

The collecting unit 12 comprises a movable cover element 13 and a collecting base 14. The cover element 13 is movable relative to the collecting base 14. The cover element 13 and the collecting base 14 are provided as half shells with parallel side walls overlapping each other, wherein the cover element 13 encompasses the collecting base 14. When the cover element 13 is moved relative to the collecting base 14, a linear movement is performed and the side walls of the cover element 13 and the collecting base 14 serve as guiding elements for the linear movement of the cover element 13 relative to the collecting base 14. A collecting opening 15 is provided between the collecting base 14 and the cover element 13. The collecting base 14 and the cover element 13 are formed to provide the collecting opening 15 with its shape in accordance with a shape of the functional element 5 of the sensor 2. The shape of the functional element 5 refers to a planar shape with the exterior sensor surface 4 provided on top thereof. In this embodiment, the functional element 5 has a circular shape, and the collecting base 14 and the cover element 13 are formed to provide the collecting opening 15 with a corresponding semi-circular shape.

The movement of the cover element 13 between a retracted position, which is shown e.g. in FIGS. 2 and 6, and a protruding position, which is shown e.g. in FIGS. 1, 3, 5 and 7, changes the size of the collecting opening 15. The collecting opening 15 has its minimum size in the retracted position, as can be seen e.g. in FIG. 6. The further the cover element 13 is moved away from the collecting base 14, the bigger the collecting opening 15, until it reaches its maximum size in the protruding position, which can be seen e.g. in FIGS. 3 and 5. Based on the increased size of the collecting opening 15 in the protruding position of the cover element 13, the collecting unit 12 collects a maximum amount of the cleaning liquid 8 dispensed from the dispensing device 6 towards the exterior sensor surface 4 of the sensor 2 via the collecting opening 15. In the retracted position, the cover element 13 is retracted into a position out of a field of view of the sensor 2.

The collection of the maximum amount of cleaning liquid 8 refers to a maximum amount of cleaning liquid 8 collected using the collecting unit 12 in the protruding position compared to the retracted position of the cover element 13.

The cover element 13 and the collecting base 14 together form an inlet for collecting the cleaning liquid 8. The cleaning liquid 8, that has entered via the collecting opening 15 a space between the cover element 13 and the collecting base 14 is trapped there between and leaves this space and the collecting unit 12 through one or more outlet opening(s) 16 of the collecting base 14 for releasing the cleaning liquid 8 collected therein through return fluid connectors 17. The cleaning liquid 8 is released from the collecting unit 12 into a reservoir, which is not shown in the figures. The reservoir is located below the collecting unit 12 so that the collected cleaning liquid 8 is transported based on gravity from the collecting unit 12 to the reservoir.

In order to realize the movement of the cover element 13 between the protruding position and the retracted position, the collecting unit 12 of the first embodiment comprises an actuator device 18 with one actuator unit 19, which is a hydraulically driven actuator unit 19 in this embodiment. Actuator device 18 and actuator unit 19 can be best seen in FIGS. 5 to 7.

The hydraulically driven actuator unit 19 comprises a hydraulic port 20 for receiving a pressurized hydraulic liquid. The hydraulic port 20 is connected in parallel with the receiving fluid connector 9 to a supply of pressurized cleaning liquid 8, which is used as hydraulic liquid in this embodiment. The actuator unit 19 comprises a piston 21, which is displaced by a force of the pressurized cleaning liquid 8. The cover element 13 is centrally support and resting on the piston 21, and the actuator unit 19 is located in an area below the cover element 13 and performs a direct pushing movement of the cover element 13 to realize the linear movement of the cover element 13 relative to the collecting base 14. Hence, when the pressurized cleaning liquid 8 is supplied to the hydraulic port 20, the piston 21 is pushed against the cover element 13. Since the actuator unit 19 is connected to the supply of the cleaning liquid 8, the actuator unit 19 is operated to move the cover element 13 in accordance with the operation of the dispensing device 6 along movement axis 22 from the retracted position into the protruding position. The area below the cover element 13 can be defined based on the movement axis 22 of the cover element 13 between the retracted position and the protruding position corresponding with the movement of the actuator unit 19, e.g. a corresponding movement of the 21 piston of the actuator unit 19. The area below the cover element 13 is located in respect to this movement axis 22 below the cover element 13.

The actuator device 18 comprises a biasing element 23 for biasing the cover element 13 into the retracted position. The biasing element 23 is provided as spring in this embodiment. When the actuator unit 19 creates a force against the biasing element 23 to move the cover element 13 from the retracted position into the protruding position, the biasing element 23 is compressed by the force exerted by the actuator unit 19. When the supply of pressurized cleaning liquid 8 is stopped, the actuator unit 19 does not exert a force onto the cover element 13 anymore. Hence, the biasing element 23 expands and automatically moves the cover element 13 towards the retracted position.

In this embodiment, the sensor cleaning device 3 is provided with a coupling between the dispensing device 6 and the actuator device 16 to move the cover element 13 into the protruding position, when the cleaning liquid dispensing unit 6 dispenses the cleaning liquid 8. The coupling is a hydraulic coupling realized by the parallel connection of the receiving fluid connector 9 and the hydraulic port 20 to the supply of the pressurized cleaning liquid 8.

The sensor unit 1 further comprises a housing 24, which at least partially encloses the sensor 2 and the sensor cleaning device 3. The housing 24 has a tubular shape with a top wall 25, which is provided as essentially flat wall. The top wall 25 is provided with a sensor opening, which is provided centrally in the top wall 25, and with further openings for the cover element 13 and the dispensing device 6. The dispensing device 6 and the collecting unit 12 with the cover element 13 are positioned circumferentially around the sensor 2 at diametrically opposite positions in respect to the sensor 2.

As can be seen in FIG. 1, in the protruding position, the cover element 13 protrudes from the top wall 25 in an outward direction. In the retracted position, as can be seen in FIG. 2, a top face 26 of the cover element 13 extends essentially flush with the top wall 25.

The sensor unit 1 is provided with latching means 27 for latching mounting of the sensor unit 1 in a corresponding receptacle of a vehicle. As can be seen e.g. in FIGS. 1 and 2, the latching means 27 are provided at a lateral wall 28 of the housing 24 of the sensor unit 1.

In one embodiment, which is not shown in the figures, the sensor unit 1 comprises a pump and/or a reservoir. The reservoir stores the cleaning liquid 8. The pump transports the cleaning liquid 8 in a pressurized state from the reservoir via receiving fluid connector 9 and hydraulic port 20 to the dispensing device 6 and the actuator device 18, respectively. The return fluid connector 17 of the collecting unit 12 is connected to the reservoir to return the collected cleaning liquid 8.

FIGS. 8 to 9 show a sensor unit 1 according to a second embodiment. The sensor unit 1 of the second embodiment is in major parts identical to the sensor unit 1 of the first embodiment.

Therefore, the subsequent description of the sensor unit 1 of the second embodiment focusses on differences between the sensor units 1 of the first and second embodiment.

Also the sensor unit 1 of the second embodiment comprises a sensor 2 and a sensor cleaning device 3, as discussed above in respect to the sensor unit 1 of the first embodiment. The sensor cleaning device 3 comprises a dispensing device 6 with a cleaning liquid dispensing unit 7 and a gas dispensing unit 10, as discussed above.

As can be seen in FIGS. 8 and 9, the sensor cleaning device 3 comprises a collecting unit 12 for collecting cleaning liquid 8 dispensed from the dispensing device 6 towards the exterior sensor surface 4.

The collecting unit 12 of the second embodiment comprises a movable cover element 13 and a collecting base 14. According to the second embodiment, the cover element 13 is movable together with the collecting base 14. Hence, the cover element 13 is coupled with the collecting base 14 and moves together with the collecting base 14. A collecting opening 15 is formed between the collecting base 14 and the cover element 13 with a fix size. Hence, the cover element 13 and the collecting base 14 together form an inlet for the cleaning liquid 8.

When the cover element 13 moves, also the collecting base 14 and the collecting opening 15 move. The movement is performed as linear along movement axis 22. In the protruding position, the collecting opening 15 is positioned in a way that enables that a maximum amount of the cleaning liquid 8 dispensed from the dispensing device 6 towards the exterior sensor surface 4 of the sensor 2 is collected through the collecting opening 15. When the cover element 13 is moved together with the collecting base 14 from the protruding position towards the retracted position, a decreasing portion of the collecting opening 15 is located in a position where the cleaning liquid 8 can enter through the collecting opening 15.

Also in the second embodiment, in the retracted position, the cover element 13 is retracted together with the collecting base 14 into a position out of a field of view of the sensor 2.

Furthermore, also in the second embodiment, the collecting base 14 and the cover element 13 are formed to provide the collecting opening 15 with its shape in accordance with a shape of the functional element 5 of the sensor 2.

In order to realize the movement of the cover element 13 between the protruding position and the retracted position, also the collecting unit 12 of the second embodiment comprises an actuator device 18 with one actuator unit 19, which is a hydraulically driven actuator unit 19 in this embodiment.

In contrast to the first embodiment, the actuator unit 19 of the second embodiment is located laterally displaced to the area below the cover element 13 and is connected to the cover element 13 with a connecting rod 29. Hence, when the pressurized cleaning liquid 8 is supplied to the hydraulic port 20, the piston 21 moves the connecting rod 29 along movement axis 22, which in turn moves the cover element 13.

FIG. 10 shows a sensor unit 1 according to a third embodiment. The sensor unit 1 of the third embodiment is in major parts identical to the sensor unit 1 of the first or second embodiment. Therefore, the subsequent description of the sensor unit 1 of the third embodiment focusses on differences between the sensor units 1 of the discussed embodiments.

The sensor unit 1 of the third embodiment comprises a sensor 2 and a sensor cleaning device 3, as discussed above in respect to the sensor unit 1 of the first embodiment. The sensor cleaning device 3 comprises a dispensing device 6 with a cleaning liquid dispensing unit 7.

As can be seen in FIG. 10, the sensor cleaning device 3 further comprises a collecting unit 12 for collecting cleaning liquid 8 dispensed from the dispensing device 6 towards the exterior sensor surface 4. The collecting unit 12 is located below the dispensing device 6 to make use of gravity for collecting the cleaning liquid 8.

The collecting unit 12 comprises a movable cover element 13 and a collecting base 14, wherein the cover element 13 is movable relative to the collecting base 14. In order to realize the movement of the cover element 13, the cover element 13 is attached with a hinge 30 at the collecting base 14. The hinge 30 is provided laterally at one side of the cover element 13, as can be seen in FIG. 10.

The cover element 13 is movable between a protruding position, which can be seen in FIG. 10, and a retracted position, in which the cover element 13 is positioned in parallel to the collecting base 14. Hence, the cover element 13 performs a tiling movement between the retracted position and the protruding position. In the protruding position, collecting opening 15 is provided laterally with respect to the cover element 13 at an opposite side compared to the hinge 30.

In detail, the collecting opening 15 is opened with a beginning movement of the cover element 13 from the retracted position into the protruding position. The further the cover element 13 is moved away from the collecting base 14, the bigger the collecting opening 15, until it reaches its maximum size in the protruding position. In the retracted position, the collecting opening 15 is not present. Based on the maximum size of the collecting opening 15 in the protruding position of the cover element 13, the collecting unit 12 collects a maximum amount of the cleaning liquid 8 dispensed from the dispensing device 6 towards the exterior sensor surface 4 of the sensor 2 via the collecting opening 15. In the retracted position, the cover element 13 is retracted into a position out of a field of view of the sensor 2.

Also in the third embodiment, the cover element 13 and the collecting base 14 together form an inlet for the cleaning liquid 8. The cleaning liquid 8, that has entered a space between the cover element 13 and the collecting base 14 is trapped there between and leaves this space and the collecting unit 12 through outlet opening 16 of the collecting base 14 for releasing the cleaning liquid 8 collected therein through return fluid connector 17.

In order to realize the movement of the cover element 13 between the protruding position and the retracted position, the collecting unit 12 comprises an actuator device 18 with one actuator unit 19, which is a hydraulically driven actuator unit 19 in this embodiment. The hydraulically driven actuator unit 19 comprises a hydraulic port 20 for receiving a pressurized hydraulic liquid. The hydraulic port 20 is connected in parallel with the receiving fluid connector 9 to a supply of pressurized cleaning liquid 8, which is used as hydraulic liquid in this embodiment. The actuator unit 19 comprises a piston 21, which is displaced by a force of the pressurized cleaning liquid 8.

As can be seen in FIG. 10, the actuator unit 19 is located in an area below the cover element 13 and performs a direct pushing movement of the cover element 13, which results in the tilting movement of the cover element 13.

The actuator device 18 comprises a biasing element 23 for biasing the cover element 13 into the retracted position. In this embodiment, the biasing element 23 is provided as spring located at the hinge 30. When the actuator unit 19 creates a force against the biasing element 23 to move the cover element 13 from the retracted position into the protruding position, the biasing element 23 is compressed by the force exerted by the actuator unit 19. When the supply of pressurized cleaning liquid 8 is stopped, the actuator unit 19 does not exert a force onto the cover element 13 anymore. Hence, the biasing element 23 expands and automatically moves the cover element 13 towards the retracted position.

In this embodiment, the sensor cleaning device 3 is provided with a coupling between the dispensing device 6 and the actuator device 6 to move the cover element 13 into the protruding position, when the cleaning liquid dispensing unit 6 dispenses the cleaning liquid 8. The coupling is a hydraulic coupling realized by the parallel connection of the receiving fluid connector 9 and the hydraulic port 20 to the supply of the pressurized cleaning liquid 8.

FIGS. 11 to 12 refer to a sensor unit 1 according to a fourth embodiment. However, FIGS. 11 to 12 merely show a collecting unit 12 for collecting cleaning liquid 8 dispensed from dispensing device 6 towards exterior sensor surface 4 of sensor 2. Details of the sensor unit 1 correspond to the sensor units 1 of one of the first, second or third embodiments.

The collecting unit 12 comprises a movable cover element 13 and a collecting base 14. The cover element 13 is movable relative to the collecting base 14. In order to realize the movement of the cover element 13, the cover element 13 is attached with a hinge 30, which is not shown in FIGS. 11 and 12, at the collecting base 14. The hinge 30 is provided laterally at one side of the cover element 13, as can be seen in FIG. 10 in respect to the third embodiment.

A collecting opening 15 is provided between the collecting base 14 and the cover element 13. The collecting base 14 and the cover element 13 are formed to provide the collecting opening 15 with its shape in accordance with a shape of the functional element 5 of the sensor 2 in accordance with the sensor unit 1 of the first embodiment. In this embodiment, the functional element 5 has a circular shape, and the collecting base 14 and the cover element 13 are formed to provide the collecting opening 15 with a corresponding semi-circular shape.

A movement of the cover element 13 between a retracted position, which is not shown in the figures, and a protruding position, which is shown in FIGS. 11 and 12, changes the size of the collecting opening 15 with the collecting opening 15 having its minimum size in the retracted position. The further the cover element 13 is moved away from the collecting base 14 towards the protruding position, the bigger the collecting opening 15, until it reaches its maximum size in the protruding position. Based on the increased size of the collecting opening 15 in the protruding position of the cover element 13, the collecting unit 12 collects a maximum amount of the cleaning liquid 8 dispensed from the dispensing device 6 towards the exterior sensor surface 4 of the sensor 2 via the collecting opening 15. In the retracted position, the cover element 13 is retracted into a position out of a field of view of the sensor 2.

Also in the fourth embodiment, the cover element 13 and the collecting base 14 together form an inlet for the cleaning liquid 8. The cleaning liquid 8, that has entered a space between the cover element 13 and the collecting base 14 is trapped there between and leaves this space and the collecting unit 12 through outlet opening 16 of the collecting base 14 for releasing the cleaning liquid 8 collected therein through return fluid connectors 17. The cleaning liquid 8 is released from the collecting unit 12 into a reservoir, which is not shown in the figures.

The collecting unit 12 of the fourth embodiment comprises an actuator device 18 with two actuator units 19, which are a hydraulically driven actuator units 19 in this embodiment, to realize the movement of the cover element 13 between the protruding position and the retracted position.

Each of the hydraulically driven actuator units 19 comprises an individual hydraulic port 20 for receiving pressurized hydraulic liquid. The hydraulic ports 20 are connected in parallel with the receiving fluid connector 9 of dispensing device 6 to a supply of pressurized cleaning liquid 8, which is used as hydraulic liquid. Each of the actuator units 19 comprises a piston 21, which is displaced by a force of the pressurized cleaning liquid 8. The pistons 21 support the cover element 13 at its lateral sides to commonly move the cover element 13, as can be seen in FIG. 12.

According to the fourth embodiment, the actuator units 19 are located in an area below the cover element 13 and perform a direct pushing movement of the cover element 13. Hence, when the pressurized cleaning liquid 8 is supplied to the hydraulic port 20, the pistons 21 are pushed against the cover element 13. Since the actuator unit 19 is connected to the supply of the cleaning liquid 8, the actuator unit 19 is operated to move the cover element 13 in accordance with the operation of the dispensing device 6 along movement axis 22 from the retracted position into the protruding position.

The actuator device 18 comprises a biasing element 23 for biasing the cover element 13 into the retracted position. In the fourth embodiment, the biasing element 23 is provided as spring located at the hinge 30. When the actuator units 19 create a force against the biasing element 23 to move the cover element 13 from the retracted position into the protruding position, the biasing element 23 is compressed by the force exerted by the actuator units 19. When the supply of pressurized cleaning liquid 8 is stopped, the actuator units 19 do not exert a force onto the cover element 13 anymore. Hence, the biasing element 23 expands and automatically moves the cover element 13 towards the retracted position.

The sensor cleaning device 3 is provided with a coupling between the dispensing device 6 and the actuator device 6 to move the cover element 13 into the protruding position when the cleaning liquid dispensing unit 6 dispenses the cleaning liquid 8. The coupling is a hydraulic coupling realized by the parallel connection of the receiving fluid connector 9 and the hydraulic ports 20 to the supply of the pressurized cleaning liquid 8.

### LIST OF REFERENCE NUMERALS

1 sensor unit
2 sensor
3 sensor cleaning device
4 exterior sensor surface
5 functional element, lens
6 dispensing device
7 cleaning liquid dispensing unit
8 cleaning liquid
9 receiving fluid connector
10 gas dispensing unit
11 receiving gas connector
12 collecting unit
13 cover element
14 collecting base
15 collecting opening
16 outlet opening
17 return fluid connector
18 actuator device
19 actuator unit
20 hydraulic port
21 piston
22 movement axis
23 biasing element, spring
24 housing
25 top wall
26 top face
27 latching means
28 lateral wall
29 connecting rod
30 hinge

1. Sensor cleaning device (3) for cleaning an exterior sensor surface (4) of a sensor (2), in particular an optical camera or a LiDAR, for use in automotive applications, comprising
a dispensing device (6) with a cleaning liquid dispensing unit (7) for dispensing a cleaning liquid (8) towards the exterior sensor surface (4) of the sensor (2),
a collecting unit (12) for collecting cleaning liquid (8) dispensed from the dispensing device (6) towards the exterior sensor surface (4), wherein
the dispensing device (6) comprises a receiving fluid connector (9) for receiving the cleaning liquid (8), and
the collecting unit (12) comprises at least one return fluid connector (17) for releasing collected cleaning liquid (8),
wherein the sensor cleaning device (3) is characterized in that,
the collecting unit (12) comprises a movable cover element (13), which is movable between a protruding position, in which the collecting unit (12) collects a maximum amount of the cleaning liquid (8) dispensed from the dispensing device (6) towards the exterior sensor surface (4) of the sensor (2) via its collecting opening (15), and a retracted position, in which the cover element (13) is retracted into a position out of a field of view of the sensor (2).

2. Sensor cleaning device (3) according to claim 1, characterized in that,
the collecting unit (12) comprises a collecting base (14) for guiding collected cleaning liquid (8) to the at least one return fluid connector (17), wherein
the cover element (13) is movable relative to the collecting base (14) and the collecting opening (15) is formed between the collecting base (14) and the cover element (13) in the protruding position, and/or
the cover element (13) is movable relative to the collecting base (14), the collecting opening (15) is formed between the collecting base (14) and the cover element (13), and a size of the collecting opening (15) is increased when the cover element (13) is moved into the protruding position, and/or
the cover element (13) is movable together with the collecting base (14), and the collecting opening (15) is formed between the collecting base (14) and the cover element (13), so that the collecting opening (15) moves with the collecting base (14) and the cover element (13), wherein in the protruding position a maximum amount of the cleaning liquid (8) dispensed from the dispensing device (6) towards the exterior sensor surface (4) of the sensor (2) is collected through the collecting opening (15).

3. Sensor cleaning device (3) according to claim 1 or 2, characterized in that,
the collecting base (14) and/or the cover element (13) is formed to provide the collecting opening (15) with its shape in accordance with a shape of a functional element (5) of the sensor (2), e.g. a sensor lens or a prism, or a protection element of the sensor (2), wherein
the exterior sensor surface (4) is a surface (4) of the functional element (5) or the protection element.

4. Sensor cleaning device (3) according to any of claims 1 to 3, characterized in that,
the collecting unit (12) comprises an actuator device (18) with at least one actuator unit (19) for moving the cover element (13) between the retracted position and the protruding position, wherein
the at least one actuator unit (19) is an electronically driven actuator unit (19), e.g. an electric motor, and/or
the at least one actuator unit (19) is a mechanically driven actuator unit (19), and/or
the at least one actuator unit (19) is a hydraulically driven actuator unit (19), and/or
the at least one actuator unit (19) is a pneumatically driven actuator unit (19).

5. Sensor cleaning device (3) according to preceding claim 4, characterized in that,
the actuator device (18) comprises a biasing element (23), in particular a spring element, for biasing the cover element (13) into the retracted position.

6. Sensor cleaning device (3) according to claim 4 or 5, characterized in that,
the sensor cleaning device (3) is provided with a coupling between the dispensing device (6) and the actuator device (18) to move the cover element (13) into the protruding position, when the cleaning liquid dispensing unit (7) dispenses the cleaning liquid (8).

7. Sensor cleaning device (3) according to preceding claim 6, characterized in that,
the sensor cleaning device (3) comprises a control unit, which performs a control of the dispensing device (6) and/or the actuator device (18) to move the cover element (13) into the protruding position, when the cleaning liquid dispensing unit (7) dispenses the cleaning liquid (8), or
the dispensing device (6) and the actuator device (18) are both operated by a supply of pressurized cleaning liquid (8).

8. Sensor cleaning device (3) according to any of claims 4 to 7, characterized in that,
the at least one actuator unit (19) for moving the cover element (13) is located in an area below the cover element (13) and performs a direct pulling and/or pushing movement of the cover element (13), and/or
the at least one actuator unit (19) for moving the cover element (13) is located laterally displaced to the area below the cover element (13) and is connected with the cover element (13) with a connecting rod (29).

9. Sensor cleaning device (3) according to any preceding claim, characterized in that,
the cover element (13) is attached with a hinge (30) and performs a tiling movement between the retracted position and the protruding position, and/or
the cover element (13) is movable in a linear direction along a movement axis (22), and/or
the cover element (13) is movable with a guide mechanism along a defined movement path.

10. Sensor cleaning device (3) according to any preceding claim, characterized in that,
the dispensing device (6) comprises a gas dispensing unit (10) for releasing pressurized gas into a direction of the exterior sensor surface (4) of the sensor (2).

11. Sensor cleaning device (3) according to any preceding claim, characterized in that,
the exterior sensor surface (4) of the sensor (2) is an exterior sensor surface (4) of a functional element (5) of the sensor (2), e.g. a sensor lens or a prism, or
the exterior sensor surface (4) of the sensor (2) is an exterior sensor surface (4) of a protection element, in particular of a functional element (5) of the sensor (2).

12. Sensor unit (1) comprising a sensor (2), in particular an optical camera or a LiDAR, for use in automotive applications and a sensor cleaning device (3) according to any preceding claim.

13. Sensor unit (1) according to preceding claim 12, characterized in that,
the sensor unit (1) comprises a housing (24), which at least partially encloses the sensor (2) and the sensor cleaning device (3), wherein
the housing (24) has a top wall (25),
in the protruding position, the cover element (13) protrudes from the top wall (25) in an outward direction, and
in the retracted position, a top face (26) of the cover element (13) extends essentially flush with the top wall (25).

14. Sensor unit (1) according to any of claims 12 to 13, characterized in that,
the sensor unit (1) comprises a reservoir for storing cleaning liquid (8),
the sensor unit (1) comprises a pump unit, which delivers cleaning liquid (8) from the reservoir to a supply duct, which is connected to the receiving fluid connector (9) of the dispensing device (6).

15. Sensor unit (1) according to any of claims 12 to 14, characterized in that,
the dispensing device (6) and the collecting unit (12) are positioned circumferentially around the sensor (2), in particular around the exterior sensor surface (4) of the sensor (2), wherein preferably the dispensing device (6) and the collecting unit (12) are positioned at diametrically opposite positions in respect to the sensor (2).

16. Sensor unit (1) comprising a sensor (2), in particular an optical camera or a LiDAR, for use in automotive applications and a sensor cleaning device (3), wherein
the sensor cleaning device (3) is provided for cleaning an exterior sensor surface (4) of the sensor (2), comprising
a dispensing device (6) with a cleaning liquid dispensing unit (7) for dispensing a cleaning liquid (8) towards the exterior sensor surface (4) of the sensor (2),
a collecting unit (12) for collecting cleaning liquid (8) dispensed from the dispensing device (6) towards the exterior sensor surface (4), wherein
the dispensing device (6) comprises a receiving fluid connector (9) for receiving the cleaning liquid (8), and
the collecting unit (12) comprises at least one return fluid connector (17) for releasing collected cleaning liquid (8),
wherein the sensor unit (1) is characterized in that,
the sensor cleaning device (3) is movable relative to the sensor (2) between a protruding position, in which the collecting unit (12) collects a maximum amount of the cleaning liquid (8) dispensed from the dispensing device (6) towards the exterior sensor surface (4) of the sensor (2) via its collecting opening (15), and a retracted position, in which the sensor cleaning device (3) is retracted into a position out of a field of view of the sensor (2).
